(19) United States
(12) Patent Application Publication
(10) Pub. No.: US 2016/0299639 A1
(43) Pub. Date: Oct. 13, 2016

(54) User interface for providing geographically delineated content

(71) Applicant: Co Everywhere, Inc., Boston, MA (US)

(72) Inventors: Daniel Alan Adams, Melrose, MA (US); Anthony Longo, Boston, MA (US)

(73) Assignee: Co Everywhere, Inc., Boston, MA (US)

(21) Appl. No.: 15/180,373

(22) Filed: Jun. 13, 2016

Related U.S. Application Data
(63) Continuation-in-part of application No. 14/610,312, filed on Jan. 30, 2015.
Application No. 14/610,312 is a continuation-in-part of application No. 14/572,270, filed on Dec. 16, 2014.
(60) Provisional application No. 62/180,993, filed on Jun. 17, 2015.
(60) Provisional application No. 61/995,015, filed on Apr. 1, 2014.
(60) Provisional application No. 61/963,849, filed on Dec. 16, 2013.
(60) Provisional application No. 61/963,850, filed on Dec. 16, 2013.

(51) Int. Cl. G06F 3/0481; H04L 12/26; G06T 11/20; H04L 29/08

(52) U.S. Cl. CPC G06F 3/0481; H04L 67/18; H04L 43/106; G06T 11/206; G06T 2200/24

(57) ABSTRACT

A system is provided for identifying and visualizing geographically delineated content and author information having an associated geographic location within a standardized geographic boundary. In contrast to a “free-form” location search, or user-drawn polygon designating an area for which to aggregate social media content, standardized geographic boundaries include predetermined geographic areas. Further, similar geographic areas may be located based on aggregated social media content.

### RELATED APPLICATIONS

This application claims priority to claims priority under 35 U.S.C. §119(e) to U.S. Provisional Patent Application Ser. No. 62/180,993 entitled “SYSTEMS AND METHODS FOR GEOGRAPHIC BOUNDARY CONTENT PROVISION,” filed Jun. 17, 2015. Further, this application is a Continuation in Part of U.S. patent application Ser. No. 14,610,312 entitled “USER INTERFACE FOR PROVIDING GEOGRAPHICALLY DELINEATED CONTENT,” filed Jan. 1, 2015, which is a Continuation in Part of U.S. patent application Ser. No. 14/572,270, entitled “SYSTEMS AND METHODS FOR PROVIDING GEOGRAPHICALLY DELINEATED CONTENT,” filed Dec. 16, 2014, which is incorporated herein by reference in its entirety. U.S. patent application Ser. No. 14/572,270 claims priority under 35 U.S.C. §119(e) to U.S. Provisional Patent Application Ser. No. 61/963,849 entitled “METHODS OF GEOGRAPHIC DELINEATION,” filed on Dec. 16, 2013, which application is herein incorporated by reference in its entirety. U.S. patent application Ser. No. 14/572,270 also claims priority under 35 U.S.C. §119(e) to U.S. Provisional Patent Application Ser. No. 61/963,850 entitled “CONTENT PROVISION BY GEOGRAPHIC DELINEATION,” filed on Dec. 16, 2013, which application is herein incorporated by reference in its entirety. U.S. patent application Ser. No. 14/572,270 further claims priority under 35 U.S.C. §119(e) to U.S. Provisional Patent Application Ser. No. 61/995,015 entitled “METHODS FOR GEOGRAPHIC DELINEATION,” filed on Apr. 1, 2014, which application is herein incorporated by reference in its entirety.

### BACKGROUND

There are many companies that provide, consume, and transfer social networking information via the Internet, such as Twitter, Facebook, MySpace, Linkedln, Pinterest, Foursquare, Yelp, and Tripadvisor, among others. Social networking sites allow individuals to access social media content related to business and commerce, as well as personal needs and desires. Content often includes text, photographs, videos, and audio files. Also, some social media content providers provide location-based capabilities such as, for example, permitting a user to perform actions based on location. For example, within one type of location-based social network, users are permitted to perform a “check-in” to particular locations, including venues such as businesses, retail locations, events, points of interest, or other locations. A check-in generally includes a process that identifies the user with a particular location at a given time, and may be recorded over time. Accordingly, location-based social networks permit users to find venues of interest, find content of interest, interact with friends, and leave comments regarding particular locations, among other functions.

### SUMMARY

At least one aspect is directed to a computer system including an interface configured to receive an input defining a first standardized geographic boundary, a location-based service including a distributed computer system having at least one processor in data communication with the interface, a delineation component executable by the at least one processor and configured to aggregate geographically delineated content including a plurality of social media posts generated by an author and having an associated geographic location within the standardized geographic boundary, and a communication component executable by the at least one processor and configured to provide the geographically delineated content.

According to one embodiment, the standardized boundary includes one of a predetermined state boundary, town boundary, neighborhood boundary, residential boundary, school boundary, hospital boundary, parcel boundary, zip code boundary, area code boundary, carrier route boundary, census boundary, shopping boundary, and subdivision boundary.

In one embodiment, the input further defines at least one query parameter. In a further embodiment, the query parameter defines author characteristics and the communication component is further configured to provide author information based on the author characteristics. According to one embodiment, the system may include a relation component configured to generate an advertisement based on the author information. In one embodiment, the query parameter defines content characteristics and the communication component is further configured to provide the geographically delineated content based on the content characteristics.

According to one embodiment, the system may include a relation component configured to generate a visualization of the geographically delineated content including an image of the first standardized geographic boundary. In a further embodiment, the relation component is further configured to filter the geographically delineated content. In one embodiment, filtering the geographically delineated content includes altering a resolution of the visualization to increase or decrease the first standardized geographic boundary to a second standardized geographic boundary. According to one embodiment, each post of the plurality of social media posts includes a timestamp, and filtering the geographically delineated content includes filtering the geographically delineated content based on the timestamp. In one embodiment, each post of the plurality of social media posts includes author information, and filtering the geographically delineated content includes filtering the geographically delineated content based on author information.

According to one embodiment, the system may include an enrichment component executable by the at least one processor and configured to aggregate enrichment data and enhance the geographically delineated content. In one embodiment, the system is configured to receive and store the geographically delineated content at a database, the database indexed based on a plurality of standardized geographic boundaries including the first standardized geographic boundary.

According to one aspect, provided is computer system including an interface configured to receive an input defining at least one query parameter, a location-based service including a distributed computer system having at least one processor in data communication with the interface, a delineation component executable by the at least one processor and configured to aggregate geographically delineated content including a plurality of social media posts having an associated geographic location and generated by an author, based on the at least one search parameter, a relation configured to identify a standardized geographic boundary for the geographically delineated content, and a communication component executable by the at least one processor and configured to provide the standardized geographic boundary.

According to another aspect, provided is a computer system including an interface configured to receive an input defining at least one search parameter or standardized geographic boundary, a location-based service including a distributed computer system having at least one processor in data communication with the interface, a delineation component executable by the at least one processor and configured to aggregate geographically delineated content including a plurality of social media posts each generated by an author, based on the at least the one search parameter or standardized geographic boundary, and a relation component executable by the at least one processor and configured to generate an advertisement targeted to one of an author of a social media post within the plurality located within the standardized geographic boundary or an author of a social media post within the plurality related to the query parameter.

According to one aspect, provided is a method including receiving an input defining a standardized geographic boundary, aggregating geographically delineated content generated by one or more author for the standardized geographic boundary, and providing the geographically delineated content.

According to another aspect, provided is a method including receiving an input defining at least one search parameter, aggregating geographically delineated content generated by one or more author based on the at least one search parameter for a standardized geographic boundary, and providing the geographically delineated content.

According to one aspect, provided is a method including receiving an input defining at least one search parameter or standardized geographic boundary, aggregating geographically delineated content generated by one or more author based on the at least one search parameter or standardized geographic boundary, and generating an advertisement targeted to one of an author located within the standardized geographic boundary or an author of a social media post related to the search parameter based on the geographically delineated content.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a block diagram showing a location-based service and system suitable for incorporating various aspects of the present invention;

FIG. 2 is a block diagram showing an example process for providing geographically delineated content that uses services, according to various examples;

FIGS. 3A and 3B show a first and second example of a visualization of a standardized geographic boundary, according to various examples;

FIG. 4 is a block diagram showing an example process for identifying a standardized geographic boundary, according to various examples;

FIG. 5 shows an example computer system with which various aspects of the invention may be practiced; and

FIGS. 6A-B show an example interface in which a visualization may be displayed, according to various examples.

### DETAILED DESCRIPTION

Embodiments disclosed herein include services, application systems, applications, and methods for providing and identifying geographically delineated content and author information having an associated geographic location within a standardized geographic boundary. In contrast to a “free-form” location search, or user-drawn polygon designating an area for which to aggregate social media content, standardized geographic boundaries include predetermined geographic areas, such as state boundaries, town boundaries, neighborhood boundaries, residential boundaries, school boundaries, hospital boundaries, parcel boundaries, zip code boundaries, area code boundaries, carrier route boundaries, census boundaries, shopping boundaries, and subdivision boundaries.

While free-form location based searches permit a user to define their own geographic boundaries, often these user defined boundaries are not uniform across multiple platforms, rating systems, or other applications, making comparison time consuming and challenging. For example, various electoral districts are based on predefined geographic boundaries. Such predefined boundaries, make user drawn boundaries impractical or impossible for voter demographic content analysis. Accordingly, content provision for standardized geographic boundaries, as described herein, permits comparison across multiple platforms, indices, rating systems, and other applications. Furthermore, standardized geographic boundaries permit navigable layers and resolutions of content within a displayed geographic location, such as information regarding social media post authors. Accordingly, various embodiments permit users and clients to make more informed location dependent decisions, such as residential and business property purchases and school district placement, among others.

Further, such embodiments permit more detailed and personalized offers, solicitations, and notifications. Such geographically delineated content may be used to perform targeting actions in relation to content authors identified within those geographic boundaries. For example, such a system that aggregates and indexes social media content in one or more standardized geographical boundaries may be adapted to analyze posted content in order to target one or more boundaries within that geographical area. Such a system may generate advertisements or instruct an advertising system or content provider to generate and send advertisements to one or more targeted authors.

Geographically delineated content can include social media content or social networking information that is relevant to one or more geographic locations. In various embodiments, geographically delineated content includes a plurality of social media posts (referred to herein as “posts” or “media posts”). Each post is respectively generated by an author, which may include a user or client, through a social media content provider. For example content can include text, photographs, videos, hyperlinks, audio files, among other data types. Content can be generated through one or more social media content providers, online repositories of information, or any other provider of location-based relevant content. Although social media content providers, as described herein, include social media platforms such as Twitter, Facebook, MySpace, Linkedln, Pinterest, Foursquare, Yelp, and Tripadvisor, in further embodiments, providers can include any social media content provider as is understood in the art (including any media that is produced by a human (user generated content), which may not necessarily be considered social media content or platforms).

Content is generated by any source of content such as social media platform users, companies, or any other source of social media content. Sources of content may permit an author to generate individual media posts including text, image content, hyperlinks, audio files, hashtags, likes, dislikes, @mentions, image content, tagged venues/places, and author information including: age, sex, topic interests, and domicile. For example, a media post may include a tweet having an avatar, a username, the author's name, a number of likes, the date of the media post, a photograph, and one or more hashtags. Such information may be derived from multiple providers using communication logic that acquires such information from one or more content providers, content generated by such content providers may be received via a push operation and stored in a database. Posts from multiple content providers may be indexed and/or tagged by location. In one embodiment, the database entry may be tagged in multiple locations.

In various aspects, geographic locations associated with media posts can refer to a country, a state, a city, a neighborhood, a building, a venue, an address, coordinates such as longitude and latitude, or any other information descriptive of a location. Although geographic location as used herein includes a single geographic location, in various embodiments, geographic location can include a plurality or a series of locations. The location may also define certain geometries and/or geographic boundaries. In various embodiments, media posts within geographically delineated content include an attached (“tagged”) geographic location.

As described above, in some embodiments, the system may track a “check-in” to particular locations, including venues such as businesses, retail locations, events, points of interest, or other locations. A check-in generally includes a process that identifies the author with a particular location at a given time, and may be recorded over time. In other embodiments, the geographically delineated content is automatically tagged with a geographic location. For example, geographically delineated content generated from a content provider device having a Global Positioning System (“GPS”) may automatically embed location information in the generated content. A processor or other component may automatically tag such entries based on their GPS location as being in particular locations (e.g., within a particular state, neighborhood, subdivision, etc.) as compared to predefined location definitions.

In further embodiments, a social media platform may allow an author to manually enter location information. While some content providers may not provide a location with generated content, location may still be inferred from intrinsic information, such as metadata associated with the content. It should be appreciated that geographically delineated content should not be limited to content tagged with a geographic location in any particular manner. Accordingly, it is appreciated that various media posts and types of content will not have location information inherently associated therewith. As such, conventional systems cannot search and provide such information by geographic location. According to one aspect of the present invention, a system may be provided that enhances such information to include additional information that can be inferred by analyzing other content that is determined to be related to the media post not having a geographic location.

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

Moreover, it is to be understood that both the foregoing information and the following detailed description are merely illustrative examples of various aspects and embodiments of the present invention, and are intended to provide an overview or framework for understanding the nature and character of the claimed aspects and embodiments. Any embodiment disclosed herein may be combined with any other embodiment in any manner consistent with at least one of the aspects disclosed herein, and references to “an embodiment,” “some embodiments,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearance of such terms herein is not necessarily all referring to the same embodiment.

Furthermore, in the event of inconsistent usages of terms between this document and documents incorporated herein by reference, the term usage in the incorporated references is supplementary to that of this document; for irreconcilable inconsistencies, the term usage in this document controls. In addition, the accompanying drawings are included to provide illustration and a further understanding of the various aspects and examples, and are incorporated in and constitute a part of this specification. The drawings, together with the remainder of the specification, serve to explain principles and operations of the described and claimed aspects and examples.

### Location-Based Systems and Processes

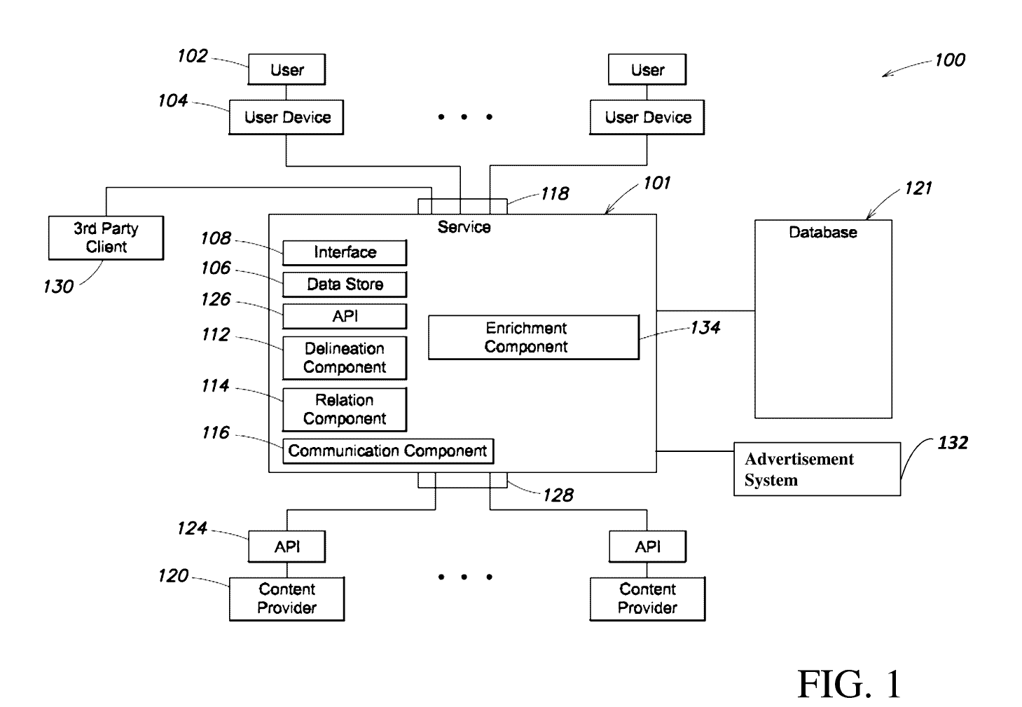

Turning now to FIG. 1, a block diagram of a location-based service and system suitable for incorporation of various aspects of the present invention is shown. For instance, the service 101 may permit one or more users (e.g., user 102) to request and receive geographically delineated content associated with an input defining a standardized geographic boundary. Similarly, the service 101 may also permit one or more users (e.g., user 102) to request and receive author information associated with geographically delineated content generated within a standardized geographic boundary. In further embodiments, the service 101 may also permit a user 102 to find a standardized geographic boundary based on one or more user inputs. In one example, such features permit the service 101, or an advertisement system 132 in communication with the service, to generate and tailor advertisements to targeted users or authors. In various embodiments, geographically delineated content and author information is provided to the user 102 in a visual display permitting the user 102 to filter, sort, navigate, and otherwise interact with the content and information. Content may be displayed on an image of a standardized geographic boundary, such as a map.

As shown, in one embodiment, the system 100 can include a computing device (e.g., user device 104) having a memory, a user interface, and one or more processors. For example, the user device 104 can include a cell phone, smart phone, PDA, tablet computer, laptop, or other computing system. Users 102 may use the interface of the user device 104 for interacting with the system 100. In other embodiments, the service 101 may permit one or more third party client systems (e.g., client 130) to request and receive geographically delineated content or author information associated with an input. In one embodiment, the service may provide geographically delineated content to a third party system based on one or more standard definitions of a geographic area.

In one embodiment, the service 101 may include one or more components. Such components may be implemented using one or more computer systems. In one embodiment, service 101 may be implemented on a distributed computer system using one or more communication networks (e.g., the Internet). In one implementation, the service is implemented in a cloud-based computing platform, such as the well-known EC2 platform available commercially from Amazon.com, Seattle, WA. Other implementations are possible and are within the scope and spirit of the invention, and it is appreciated that other platforms may be used.

Service 101 may include a webserver which is capable of serving as a front end to the location-based service 101. User devices 104 and/or clients 130 may receive and display geographically delineated content and/or author information associated with geographically delineated content, aggregated and provided by service 101. Notably, devices 104 and clients 130 may include controls that perform various functions in an application (e.g., a mobile application). Further, such devices 104 and clients 130 provide an input generated by the user 102 or the client 130. The user, or client, input may be used to perform one or more functions, such as defining a standardized geographic boundary, defining author characteristics, or defining content characteristics.

Service 101 may also provide one or more related services, such as a service for providing location-based social media content and/or author information associated with location-based social media content. Services may be integral to service 101 or may alternatively operate in conjunction with service 101 (e.g., by communicating with the service 101 through an Application Programming Interface (API)). In some implementations, the service 101 is configured to execute one or all of a plurality of components including a delineation component 112, a relation component 114, a communication component 116, and an enrichment component 134. In further embodiments, the service 101 may include means for performing any or all of the processes described herein.

The interface 108 of the service 101 is configured to receive from the user device 104, or the client 130, at least one input. In one embodiment, the input defines a standardized geographic boundary for which to provide content. In various implementations, the input includes a selection from a list of predefined boundaries, a selection of a standardized geographic boundary defined in a visual geographic representation of a geographic location (e.g., a map), or a natural language-based identification of a standardized geographic boundary (e.g., keywords). For example, the user interface may be configured to receive as an input: a country, a state, a city, a neighborhood, a building, a venue, an address, coordinates such as longitude and latitude, or any other information descriptive of a location. In the event that an input does not properly align with a standardized geographic boundary, the service 101 may match the user input to the closest related standardized geographic boundary. In one embodiment, service 101 may require one or more definitions of a standardized boundary, which may change over time. These definitions may be adaptively applied to previously-received and stored social media data.

In some embodiments, the input may define one or more query parameters such as author characteristics or content characteristics. The query parameters may be selected from a list (or other visual presentation) or entered by the user as keywords. For example, author characteristics may specify requested author information, and content characteristics may specify the type or topic of requested geographically delineated content. As used herein, author information may include any information descriptive of an author of social media content such as any information describing an author on a social media platform. For example, author information may include: the author's display name, the author's username, the location of the author, the author's website, the author's biography, the author's source application URL, the author's follow count, a count of how many authors are following the author, the author's total post count, the author's post count in a standardized geographic boundary, how many impressions the author has, the author's influence score, age, gender, interests, domicile, occupation, date of birth, the school that the author has or is attending, the author's relationship status, approximate income, and recent activity, to name a few.

In one embodiment, the input permits the user 102 to specify a type or topic of geographically delineated content for which to identify a standardized geographic boundary. Similarly, the input may also permit the user 102, or client 130, to specify characteristics of authors for which the service identifies a geographic location. For example, the interface 108 can be configured to receive an input consisting of “dog owners over 20 years old.” After the user 102 or client 130 has entered the input, activation of a search indicator prompts the service 101 to identify standardized geographic boundaries within which one or more authors generating social media posts match the input (i.e., dog owners over 20 years old).

That is, according to one embodiment, service 101 may be used to locate particular standardized geographic boundaries responsive to some input criteria and the social media posts occurring within those particular boundaries. This may be important to delivering, in real time, messages to in-location systems. For example, determining in-event posts by attendees of a concert, and delivering timely advertisements to mobile devices. Further, it may be useful from other predefined geographies for the purpose of evaluating trends or locating additional geographic areas for geo-targeting similarly-behaving users.

In one embodiment, the service 101 may store information for each particular user or client, including inputs or preferences defining a standardized geographic boundary. Specifically, after receiving the input via the interface 108, the user 102 or client 130 may activate a save indicator prompting the service 101 to store the entered input at a data store 106. In further embodiments, the service 101 may store aggregated geographically delineated content and/or author information for a standardized geographic boundary for a user or client. In various embodiments, the user 102 or client 130 can label or otherwise “name” stored data or information. Stored inputs can be associated with user accounts and recalled from the data store 106. For example, the service 101 can be configured to associate an entered input with a unique identifier associated with the user or client. The service 101 can then be configured to aggregate and provide geographically delineated content relating to the unique identifier.

It is appreciated that users of the systems, methods, and services described herein may be interested in social media content or authors generating content within the same standardized geographic boundary over periods of time, for example, the user 102, or client 130, may make the same request for geographically delineated content three times a week. Similarly, a user 102 or client 130 may be interested in author information regarding new authors that enter or leave the same standardized geographic boundary (e.g., potential customers walking within a predetermined distance of a store location within a standardized geographic boundary). Accordingly, the service 101 permits the user 102, or client, to store entered inputs for efficiency and convenience.

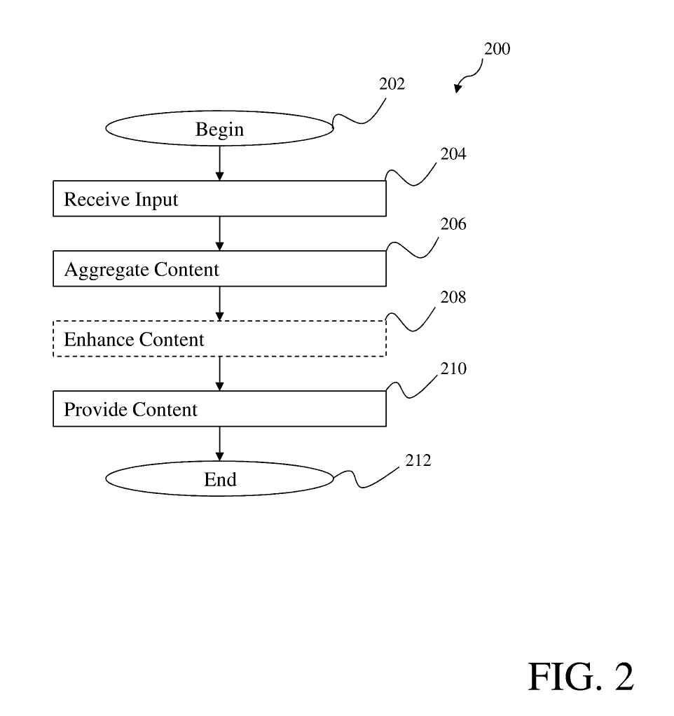

With continuing reference to FIG. 1, FIG. 2 shows an example process (e.g., process 200) in accordance with one embodiment. At block 202, the process 200 begins. At block 204 an input is received from a user or a client, over a network 118. While in one example the input may define a standardized geographic boundary (as described above), in other examples the input may define one or more query parameters. For example, the input may define one or more author characteristics or content characteristics. At block 204, a website or application (e.g., application executing on the user device 104) may be displayed to the user 102. Alternatively, an interface such as an API (e.g., API 126) may be provided to an application for providing the input to another application or system, such as the client 130. As discussed above, the input may be received at the interface 108 of the service 101. Also, the input may be received from a third party application or system that utilizes location-based services.

A component within the service 101 is configured to communicate with at least one source of content, such as a content provider 120, and/or a database (e.g., database 121) to perform a query. In various embodiments, the system 100 may include a plurality of databases, each database storing social media content and author information. The service 101 is configured to store geographically delineated content indexed within a shared database (e.g., database 121). While in one embodiment performing a query includes requesting social media content from a content provider, (e.g., Twitter), in other embodiments, the act of performing a query includes requesting content from the database 121. Content may be stored and indexed as further described below.

As discussed above, the input received by the interface 108 further can include one or more query parameters specifying the geographically delineated content or author information requested. Accordingly, the user 102 or client 130 can specify the type or topic of geographic delineated content that is aggregated and provided by the service 101.

In one embodiment, responsive to receiving the input the delineation component 112 generates a query compatible with the one or more content providers 120 or the database 121, based on the standardized geographic boundary or the query parameters. For example, the query can be formatted to request geographic delineated content from one or more content provider APIs 124. The APIs 124 associated with one or more content providers 120 permit the exchange of geographic delineated content. However, in other various implementations, the delineation component 112 is configured to generate a query for the content provider without using an associated API. It is appreciated that various content provider APIs may have different limitations and accordingly, in various implementations, the query is formatted specifically for each content provider. In one embodiment, the system receives feed from multiple content providers periodically and stores the information in a content database. One implementation is directed to accessing this database directly.

In one embodiment, a content provider 120 is queried by specifying a geographic point, for example a longitude and latitude, and designating a radius around that point. Additionally, a time period, or other criteria, may be specified. Although described above as performing one query, in various embodiments the delineation component 112 is configured to perform multiple queries in response to receiving a client or user input. For example, the delineation component 112 can be configured to perform a second and a third query to ensure that all areas of the standardized geographic boundary are covered.

The service 101 may also be capable storing information in one or more content databases 122 prior to querying the database 121. Such an implementation provides up-to-date content while increasing the speed and efficiency of the service 101. For instance, the service 101 may be configured to gather and store geographically delineated content (e.g., location based social media content), such as text, photographs, videos, audio files received from at least one content provider 120, and any author information, continually, periodically, or intermittently. Accordingly, in some examples the service 101 may not need to query the content providers 120 as relevant content and information may be available at the database 121.

In one implementation, received content is stored and indexed in a geographic quadrant based storage grid. When visualized, the grid resembles a mesh placed over the planet(e.g., Earth), in which grid lines run parallel to longitude and latitude lines. Accordingly, received geographic content is stored in location-based quadrants related to the tagged location of the content.

In one embodiment, these location-based quadrants are mapped to predefined geographic locations. In other embodiments, geographically delineated content is stored in a time-based grid, in which content is stored based on the time the content was generated by the content provider. In other embodiments, content can be stored in a time-received-based grid, in which content is stored based on the time the geographic content was received by the delineation component. In further embodiments, the received content can be stored in a subject-based grid, in which content is stored based on the source or the type of the geographically delineated content (e.g., Twitter, Facebook, MySpace, Linkedln, Pinterest, or Tumblr content). It should be appreciated that geographically delineated content can be stored in any other fashion as is suitable for geographically delineated content.

In various embodiments, one or more components of the service 101 are configured to automatically generate datum content responsive to receiving geographically delineated content from one or more content providers 120. For example, datum content may correspond with the source content of each individual media post within the received geographically delineated content. Datum includes a concentration of the bare minimum information necessary to support a search and analysis of stored geographically delineated content. For example, while full image meta data is stored in a source document, the associated datum document only contains a list of metrics, otherwise referred to as feature names, e.g., “author,” “sport,” etc. The datum content reduces the file size and concentrates contents of the datum document to permit the service 101 to efficiently and rapidly convert a query against the datum content and aggregate geographically delineated content. As understood, file size refers to the amount of space consumed by a file, such as a datum document. Typically, file size is measured in bytes. It should be appreciated that a prohibitively large number of media posts may be generated by multiple users of various social media content providers that could be retrieved by a particular service. Because of the large numbers of items that could be queried, viewed, etc., by a system, a more efficient method of working with such items may be necessary.

Additionally, maintaining a full set of source content, permits the service 101 to further analyze the source content, debug the process, and perform other maintenance operations. One or more components can additionally be configured to denormalize key information into the datum content to optimize queries and analysis, for example, author information including username, follower count, avatar, author bio, etc. Such an embodiment permits the service 101 to perform one or more of the aspects discussed below, such as detecting high influence authors or filtering geographically delineated content.

For example, a media post may include all of the information associated with a self-taken Instagram picture posted at Gillette Stadium in Foxborough, MA during a professional football game. Generation of the datum document (referred to herein also as story datum) can include analysis of the meta data, information, or other data associated with the post that may suggest the topics, sports, football, rugby, and soccer. However, only “sport” and “football” are included in the datum document, as rugby and soccer are not relevant to a professional football game. The datum document also includes “person”, as included in the picture were facial features.

The datum may also include hashtags, and location information. In one embodiment, the datum may include different types of location information that are indicative of the source of the location information or otherwise indicate how the location information should be used by the system. For instance, as referred to herein, the system may define and use genuine or precise location information. As used herein, genuine location refers to a referential geographic position, such as a venue or store location, and precise location refers to navigational positioning, such as GPS location or longitudinal and latitudinal coordinates. Accordingly, in this example, the datum would include genuine_location true and precise_location false. Because the picture was taken at Gillete Stadium, the genuine location is included, but the precise location is not.

Based on the foregoing, the media post may be included in all queries and analysis of geographically delineated content associated with the Gillete Stadium. In various embodiments differentiating between genuine location and precise location can include or exclude media posts displayed in a visual representation. Omitting media posts not having a precise location for a visualization of a standardized geographic boundary prevents the build-up of artificially inflated “hotspots” of content for a particular discrete point within the identified location. Although described herein generally as aggregating geographically delineated content responsive to querying a geographically delineated content database, in various embodiments, querying a database includes identifying a story datum document and converting the query to return source content including one or more media posts. Datum content may be stored in any manner as described herein, such as in a geographic quadrant based storage grid. It should be appreciated that some or all of this datum content and its functionality may be made available to one or more clients directly, or be provided to a third party system (e.g., via am API).

As such, in various embodiments, the delineation component generates a query compatible with the database 121. Querying database 121, instead of the content providers 120, or in addition to the content providers 120, offers numerous benefits such as improved speed, precision, and accuracy. Furthermore, such process permits content enhancement as is described herein. As discussed herein, the delineation component 112 may be configured to query one or more content providers 120 and receive geographically delineated content automatically to ensure an accurate and updated database of content. In one embodiment, the delineation component is configured to continually query content providers for content relative to frequently requested standardized geographic boundaries. For example, the delineation component 112 can be configured to automatically and continually query and aggregate geographically delineated content from Twitter in the Boston, MA boundary. Automatic queries may be time scheduled, may be random, or may be variable based upon the activity within a particular geographic location. In various embodiments, the frequency and range of automatic queries and aggregations are based on the frequency and/or volume of user or client inputs. In other embodiments, the frequency and range of automatic queries are based on social events (e.g., concerts, sport events, weather, news stories, etc.).

In some embodiments, the delineation component 112 is further configured to delay, postpone, or “put to sleep” automatic queries. For example, the delineation component 112 may delay automatic queries for infrequently requested standardized geographic boundary. In this regard, the service 101 can determine whether content requested from a particular location will likely be requested, and delay the query and aggregation if necessary. Delay, postponement, and “put to sleep” configurations permit the service 101 to allocate computing resources. Although discussed herein as performed by a delineation component 112, in various other embodiments, querying one or more content providers 120 and aggregating geographically delineated content may be performed by a plurality of components.

At block 206, the delineation component 112 is configured to aggregate the geographically delineated content received from the query. In response to performing the query, the delineation component 112 aggregates the geographically delineated content having an associated geographic location within the standardized geographic boundary. Content may be from one or a plurality of content providers 120, as discussed above, and in one or a plurality of formats. Content can include text, photographs, videos, and/or audio files, and in additional embodiments, enrichments. In various embodiments, aggregating geographically delineated content includes aggregating author information. For example, in one embodiment author information may be extracted from individual media posts of the geographically delineated content. In other embodiments, author information may be aggregated from author profiles stored, for example, at the data store 121. In further embodiments, author information may be aggregated from one or more author accounts on various social media platforms, such as Twitter, Facebook, MySpace, Linkedln, Pinterest, Foursquare, Yelp, Tripadvisor and Tumblr, among others. Aggregated content and author information may be stored as described above.

At block 210, the communication component 116 is configured to provide the aggregated geographically delineated content or author information to the one or more user devices (e.g., user device 104) or clients (e.g., client 130) permitting the respective user or client to view the geographically delineated content and/or author information. In further embodiments, the communication component 116 may also distribute user or client generated inputs or geographically delineated content to social networking sites or social media content providers.

In various embodiments, one or more components of the service 101, for example the enrichment component 134, may enrich (i.e., enhance) geographically delineated content (act 208). In various embodiments, content may be enriched automatically upon receipt from a content provider 120. It is appreciated that enriched aggregated geographically delineated content benefits the user, or client, by permitting real-time access to more content, more relevant content, and detailed social media content across multiple social content provider platforms. Accordingly, users receive more robust and interconnected aggregation of content. Various embodiments also permit more efficient, swift, and detailed user queries to return more relevant content. For example, often media posts received from Twitter will not include a location. In various embodiments, enrichment data including location information may be associated with the Twitter post. As such, users not only receive more detailed information, they will receive content that would not have otherwise been detected or found.

For example, individual media posts of the plurality of media posts may be deconstructed into a plurality of dimensions, such as an author dimension, an image dimension, a content dimension, and a location dimension. Each dimension may be enhanced with enrichment data to provide a more robust aggregation of geographically delineated content. Generally, dimensions include divisions of information, data, and meta information intrinsic to the media post. For example, the author dimension of a media post may include an avatar and a username of the author that generated that media post. One or more components of the service may be configured to automatically aggregate enrichment data related to at least one of the dimensions of each of the individual media posts. In various embodiments, aggregating enrichment data includes analyzing the dimensions of each individual media post. In particular, the enrichment component 134 can be configured to realize an identifier associated with a profile having enrichment data. For example, in various embodiments this may include realizing and querying an author profile, a content profile, a location profile, or an event profile stored within the database 121. Profiles may include repositories of meta data extracted from previous posts. Enrichment data can include author profile information, venue information, content information, location information, event information, or any other information not provided by the content provider from which the media post is provided.

As discussed herein, enhancing at least one of the individual media posts includes adding, exposing, identifying, or otherwise providing information, data, meta data, or meta information not inherent to the associated media post. It is appreciated that often a content provider 120 will not provide a full story associated with a media post. For example, in various embodiments, enhancing the plurality of media posts includes providing a visualization of enrichment data to present a more robust narrative of the story told by the media post. Enhancing the plurality of media posts, can include providing additional data related to at least one of an author dimension, a content dimension, a location dimension, or an image dimension. In further embodiments, enhancing the aggregated geographically delineated content with enrichment data permits the service to categorically group related media posts that would not have otherwise been identified as related.

In various embodiments, the relation component 114 may generate a visualization from the aggregated geographically delineated content. For example, the visualization may include an image of the standardized geographic boundary. For example, the image may include a street map, a satellite image, a mass transit map, or a geographic depiction. In various embodiments the visualization may include a heatmap of the provided geographically delineated content. As used herein, one embodiment of a heatmap visualization refers to a volume-based geographically delineated content depiction. Individual posts may be displayed by associated location within the visualization, or displayed as one or more groups of content or information.

The heatmap visualization may further include one or more indicators layered over the image of the geographic location. The indicators are configured to show the density of the volume of the geographically delineated content for a standardized geographic boundary, or a series of boundaries, on the image and can include but should not be limited to colors, shapes, and images. In one implementation, the heatmap visualization shows a range of colors conveying the volume of social media content in the geographic location to help the user or client understand the geographic layout of social media content or activity. For example, a heatmap visualization for the standardized geographic boundary of Boston, MA, may show a higher volume of Twitter content in the North End neighborhood than the South End or South Boston neighborhoods.

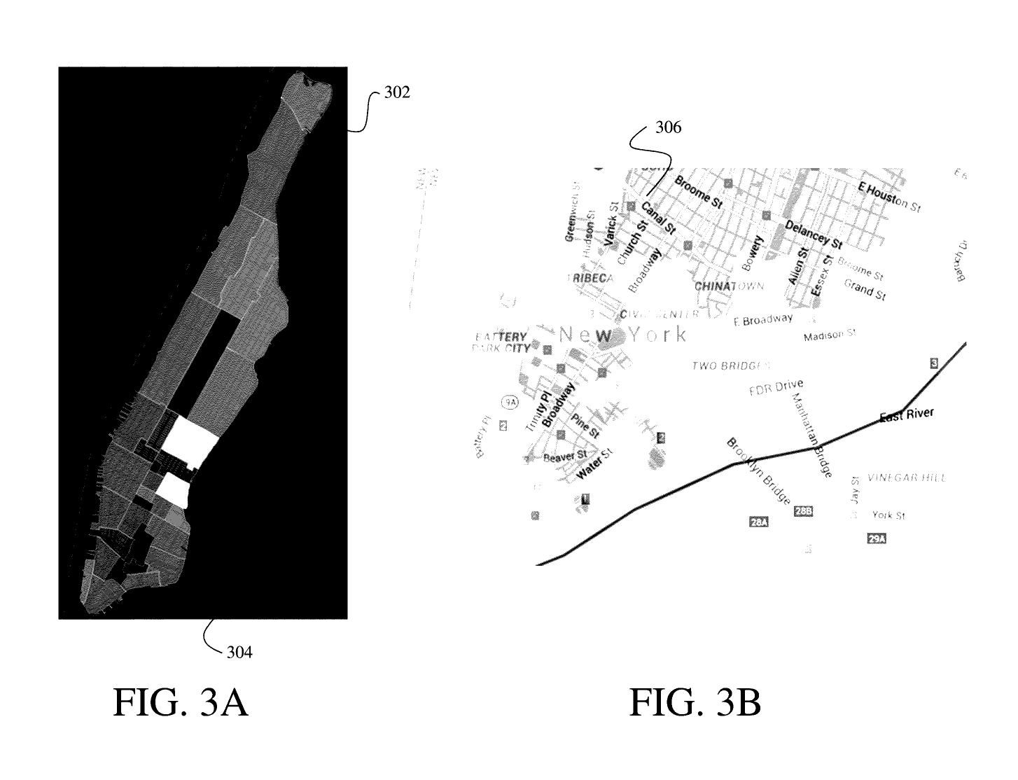

FIG. 3A, shows one example of a visualization including an image of a first standardized geographic boundary 302 (the standardized geographic boundary of Manhattan is shown). FIG. 3A additionally shows the first standardized geographic boundary 302 including a plurality of smaller standardized geographic boundaries 304 within the bounds of the first boundary 302. For example, FIG. 3A shows the neighborhood boundary of Manhattan including, for example, the Upper East Side, the Upper West Side, Midtown East, the Theater District, and Murray Hill, among others. As described herein, users or clients may further filter geographically delineated content or author information by selecting a second standardized geographic boundary (e.g., the Upper East Side) to narrow the displayed content. FIG. 3A additionally shows each smaller standardized geographic boundary 304 within the boundary of Manhattan as including a grayscale indicator of geographic delineated content or author information. For example, in FIG. 3A, brighter boundaries include a denser aggregation of associated content or information.

In further embodiments, heatmap visualizations may include indicators configured to show the density of author information for a standardized geographic boundary. The indicators are configured to show the density of the volume of author information for a standardized geographic boundary, or a series of boundaries, on the image and can include but should not be limited to colors, shapes, and images. For example, a heatmap visualization for the standardized geographic boundary of Boston, MA, may show a higher volume of authors having an interest in motorcycles in the North End neighborhood than in the South End or South Boston neighborhoods.

FIG. 3B shows a zoomed-in view of the Financial District and Battery Park City boundaries of FIG. 3A. The heatmap visualization of FIG. 3B shows one or more indicators 306 layered over the image of the standardized geographic boundaries. The indicators 306 are configured to show the density of the volume of the geographically delineated content or author information for a discrete spatial area within each of the boundaries. As shown, the indicators 306 include a range of colors conveying the volume of social media content in the geographic location to help the user or client understand the geographic layout of social media content or activity.

In some embodiments, the visualization permits the user 102 or client 130 to interact with the geographically delineated content or author information. In particular, the interface 108 is configured to permit the display of geographically delineated content in response to selection of one of the plurality of indicators overlayed the image of the geographic location. In other embodiments, the user 102 or client 130 may engage with the visualization by adjusting one or more filters. For example, filters may include author information, time stamp, content source, content type (e.g., text, video, photo, etc.), hashtags, keywords, @mentions, or image content (computer vision meta, topics) tagged venues/places. Responsive to selection of a filter, one or more components of the service 101, such as the relation component 114 are configured to re-display the content or author information based on the selected filter. For example, selection of an age filter may permit the user to review content and author information based on the age of the authors within the standardized geographic boundary.

In one embodiment, the visualization is determined in response to aggregating geographically delineated content for an identified geographic location over a period of time. Accordingly, historical data permits users 102 and clients 130 to analyze trends and fluctuations in social media content based on a time stamp of media posts. In various embodiments, users may interact with the visualization by changing the period of time for which geographically delineated content is displayed. For example, a default visualization for a standardized geographic boundary may include all geographically delineated content available. Users 102 may reduce the displayed geographically delineated content by narrowing the time period based on time, day, week, month, year, season, or any other descriptor of time. In one embodiment, posts may be displayed over a period of time based on their post time and automated within the display. Such implementations not only permit the user 102 to determine where content is being generated, who is generating the content, why the content is being generated, but also when the content is being generated. This permits the user 102 to determine time based statistics, such as when a neighborhood wakes up, when it goes to sleep, and when it takes lunch breaks or vacation days.

For purposes of illustration, in one example the service 101 may receive a user input defining the Ithaca, N.Y. boundary and the query parameters “coffee drinkers.” Responsive to receiving the input, and activation of a search indicator, the delineation component 112 is configured to aggregate geographically delineated content related to coffee drinkers and having a geographic location associated within the Ithaca, NY boundary. This may include aggregating social media content related to authors who enjoy drinking coffee, social media content related to drinking coffee, social media content related to coffee brands, social media content expressing a positive sentiment regarding coffee, or social media content expressing a negative sentiment regarding other hot beverages, for example. Author information is determined for each individual media post within the aggregated content. This may include consulting one or more author profiles stored at the database, extracting author information from the media post, or requesting author information from one or more content providers. The resulting author information is provided to the user or client in an interactive visual display. In further examples, the author information may be displayed in one or more visualizations permitting the user to interact with the author information, for example exploring individual authors, or filtering the author information based on a timestamp of an associated media post.

In another illustration, the service may receive a user input defining the Ithaca, NY boundary and the span of time 4 p.m. to 6 p.m. on May 20, 2009. Responsive to receiving the input, and activation of a “search” indicator, the delineation component 112 is configured to aggregate geographically delineated content having a geographic location associated within the Ithaca, N.Y., boundary and a timestamp between 4 p.m. and 6 p.m. This may include determining a timestamp for a social media posts if no timestamp is provided. Author information is determined for each individual media post of the aggregated geographically delineated content. This may include consulting one or more author profiles stored at the database, extracting author information from the media post, or requesting author information from one or more content providers. The resulting author information is provided by the communication component to the user or client in a visualization allowing the user or client to interact with the author information. Users may filter, sort, and otherwise interact with the display via the respective user device. Such implementations permit a user or client to determine who is generating content at a given time, and in particular, who is generating what type of content at a particular time.

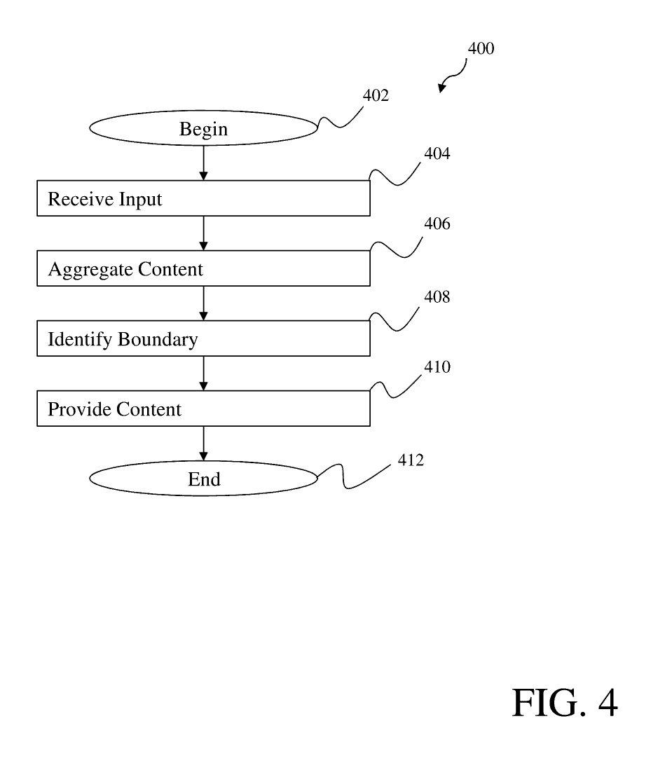

With continuing reference to FIG. 1, FIG. 4 shows an example process (e.g., process 400) for identifying a standardized geographic boundary responsive to receiving an input from a user or client. For instance, one or more components of the service 101 may be configured to analyze aggregated geographically delineated content to identify one or more standardized geographic boundaries having social media posts generated therein that correspond to the user input. Alternatively, one or more components of the service 101 may be configured to analyze the aggregated geographically delineated content and provide social media content, author information, or other suggestions to the user or client. For example, the service 101 may provide identifications of standardized geographic boundaries that are similar to a user defined standardized geographic boundary. In one embodiment, the relation component 114 compares individual media posts of the geographically delineated content based on associated geographic locations for each media post. Standardized geographic boundaries are matched to the associated geographic locations and ranked based on volume of media posts, density of media posts, or any other metric, to determine a relevancy to the user input. Based on the comparison, the service 101 may suggest one or more standardized geographic boundaries, for example, those having the largest volume, or largest density of media posts.

The process 400 begins at block 402 wherein an input is received from a user or a client, over a network 118. As described herein, in various embodiments the input may define one or more query parameters. For example, the input may define one or more author characteristics, a content type, or a particular location type (e.g., stores, events, festivals, etc.). At block 404, a website or application (e.g., application executing on the user device 104) may be displayed to the user 102. Alternatively, an interface such as an API (e.g., API 126) may be provided to an application for providing the input to another application or system, such as the client 130. As discussed above, the input is received at the interface 108 of the service 101. Also, the input may be received from a third party application or system that utilizes location-based services.

Responsive to receiving the input from the user, geographically delineated content relating to the user input is aggregated by the delineation component (act 406). As described above with reference to act 306 of FIG. 3, content may be aggregated from the database 121, one or more content providers 120, or a combination of the database 121 and one or more content providers 120. Processes for aggregating content are further described above with reference to FIG. 3.

Based on the aggregation of geographically delineated content related to the user input, one or more components of the service 101, such as the relation component 114, are configured to compare individual media posts of the geographically delineated content to determine one or more standardized geographic boundaries that best fit the geographically delineated content (act 408). In various embodiments, geographic locations (such as check-ins) associated with each individual media post of the geographically delineated content are compared. Based on the comparison, the standardized geographic boundaries are ranked. Rankings may be based on volume, density, concentration, percentages, or any other suitable metric. While in one embodiment, the service 101 may suggest to the user 102 or client 130 only the standardized boundary having the highest ranking, in other embodiments, the service may suggest to the user 102 or client 130 the standardized boundaries having the lowest rankings (act 410). In further embodiments, the entire rankings may be provided by the service.

For purposes of illustration, in one example the service 101 may receive a user input having the query parameters: “coffee drinkers.” Responsive to receiving the input, the delineation component 112 is configured to aggregate geographically delineated content related to coffee drinkers. This may include aggregating social media content related to authors who enjoy drinking coffee, social media content related to drinking coffee, social media content related to coffee brands, social media content expressing a positive sentiment regarding coffee, or social media content expressing a negative sentiment regarding other hot beverages, for example. A geographic location is determined for each social media post lacking a location and each location associated with a post is compared. Based on the comparison, a ranking of standardized geographic boundaries is generated, and the highest ranked (i.e., most relevant) boundary is provided to the user or client. As discussed above, boundaries may have different resolutions, or different metes and bounds. Accordingly, in one embodiment, the user 102 may specify which type of boundary is desired (e.g., state boundary, town boundary, neighborhood boundary, residential boundary, school boundary, hospital boundary, parcel boundary, zip code boundary, area code boundary, carrier route boundary, census boundary, shopping boundary, and subdivision boundary). As further discussed above, the boundary may be displayed as a visualization including representations of the geographically delineated content within the boundary. Users may interact with the visualization to increase or decrease the resolution of the visualization to increase or decrease to a second boundary to further explore the location associated with “coffee drinker” related data. For example, such an implementation permits a user 102 or customer 130 to discover geographic locations desirable for a coffee store or café.

As described above, in various embodiments geographically delineated content may include, or be associated with, author information. Accordingly, in various embodiments the service 101 may identify a standardized geographic boundary based on author information. Such an embodiment permits a user 102 or client 130 to locate particular content authors for customer analysis, targeted advertising, influencer tracking, various demographic based analysis, income analysis, and other people based statistics.

In another illustration, the service 101 may receive a user input having the search parameter(s): “shoes and jogging.” Responsive to receiving the input, the delineation component 112 is configured to aggregate geographically delineated content and rank standardized geographic locations as described above. Based on the generated ranking, the service 101 may facilitate the identification of geographic locations for advertising, such as targeted advertising. For example, the generated ranking may indicate that there is a strong density of authors having an interest in “shoes and jogging” in the Allston, Mass., neighborhood of Boston, and a low density of authors having an interest in the Dorchester, Mass., neighborhood. Accordingly, in various embodiments, the relation component may permit a user to generate one or more advertisements for one or more of the authors of the aggregated geographically delineated content and/or any author identified within the standardized geographic boundary. In some embodiments, the service may instruct the advertisement system or a content provider to generate and deliver a targeted advertisement to one or more authors. Advertisements may be delivered via a handle of a social media platform (e.g., username), via a mailer list, or via postal mail. In various embodiments, advertisements are based on authors having an influencer rating above a predetermined threshold.

In another illustration, one or more components of the service 101, may generate a targeted advertisement or instruct the advertisement system or a content provider to generate a targeted advertisement for an author within a standardized geographic boundary responsive to that author generating a social media post within the boundary. For example, an author may post that they are shopping for shoes within the Allston, MA, neighborhood of Boston. In such an embodiment, the delineation component 112 is configured to aggregate geographically delineated content for a standardized geographic boundary (e.g., a neighborhood boundary), the geographically delineated content including social media posts such as the author's “shopping for shoes” post. Responsive to aggregating the geographically delineated content, one or more component may analyze individual media posts to determine the author associated with each post. The relation component may then permit the generation of one or more targeted advertisements deliverable to the determined authors, such as a shoe store advertisement deliverable to the author of the “shopping for shoes” post. In various implementations, advertisements may be generated by one or more components of the service 101, such as the relation component, generated through the advertisement system 132 in communication with the service 101, or generated through one or more of the social media content providers 120.

In another illustration, the service 101 may permit a user to find standardized geographic boundaries having similar author information and geographically delineated content to a defined standardized geographic boundary. For example, the service 101 may receive a user input defining a standardized geographic boundary of Ithaca, N.Y. Responsive to receiving the input, the delineation component 112 is configured to aggregate geographically delineated content having an associated geographic location within the Ithaca, N.Y. boundary. One or more components of the service, such as the relation component are configured to analyze the aggregated content to determine metrics for comparison to geographically delineated content generated within other standardized geographic boundaries. This may include, among other metrics, author information, the type or topic of geographically delineated content, or any other meta data associated with social media posts. Such information permits the relation component to compare the metrics to metrics of other standardized geographic boundaries to identify similar standardized geographic boundaries. Returning to the example, responsive to analyzing aggregated geographically delineated content for the defined boundary of Ithaca, N.Y., the relation component may determine that boundary of Allston, Mass., has similar metrics. Related boundaries may be displayed to a user in an interactive list allowing the user to selectively display a visualization of each related boundary and the respective content and author information. Such an embodiment provides users and clients with a tool to explore related markets, for example, for advertising and solicitation.

### Example Computing Device Implementations

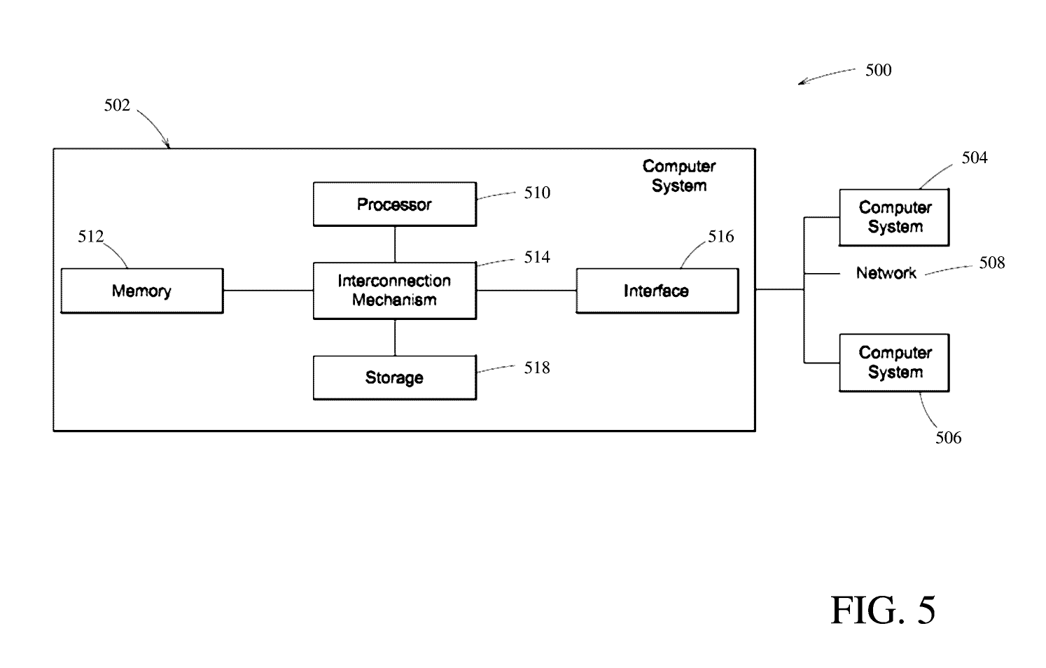

Referring to FIG. 5, there is illustrated a block diagram of a distributed computer system 500, in which various aspects and functions are practiced. As shown, the distributed computer system 500 includes one or more computer systems that exchange information. More specifically, the distributed computer system 500 includes computer systems 502, 504, and 506. As shown, the computer systems 502, 504, and 506 are interconnected by, and may exchange data through, a communication network 508. The network 508 may include any communication network through which computer systems may exchange data. To exchange data using the network 508, the computer systems 502, 504, and 506 and the network 508 may use various methods, protocols and standards to communicate information, including, among others, Fibre Channel, Ethernet, Wireless Ethernet, Bluetooth, IP, IPV6, TCP/IP, UDP, DTN, HTTP, FTP, SMS, MMS, SS7, JSON, SOAP, CORBA, REST, and Web Services. To ensure data transfer is secure, the computer systems 502, 504, and 506 may transmit data via the network 508 using a variety of security measures including, for example, SSL or VPN technologies. While the distributed computer system 500 illustrates three networked computer systems, the distributed computer system 500 is not so limited and may include any number of computer systems and computing devices, networked using any medium and communication protocol.

As illustrated in FIG. 5, the computer system 502 includes a processor 510, a memory 512, an interconnection element 514, an interface 516 and data storage element 518. To implement at least some of the aspects, functions, and processes disclosed herein, the processor 510 performs a series of instructions that result in manipulated data. The processor 510 may be any type of processor, multiprocessor or controller. Example processors may include a commercially available processor such as an Intel Xeon, Itanium, or Core processor; an AMD Opteron processor; an Apple A4 or A5 processor; an IBM Power5+ processor; an IBM mainframe chip; or a quantum computer. The processor 510 is connected to other system components, including one or more memory devices 512, by the interconnection element 514.

The memory 512 stores programs (e.g., sequences of instructions coded to be executable by the processor 510) and data during operation of the computer system 502. Thus, the memory 512 may be a relatively high performance, volatile, random access memory such as a dynamic random access memory (“DRAM”) or static memory (“SRAM”). However, the memory 512 may include any device for storing data, such as a disk drive or other nonvolatile storage device. Various examples may organize the memory 512 into particularized and, in some cases, unique structures to perform the functions disclosed herein. These data structures may be sized and organized to store values for particular data and types of data.

Components of the computer system 502 are coupled by an interconnection element such as the interconnection element 514. The interconnection element 514 may include any communication coupling between system components such as one or more physical busses in conformance with specialized or standard computing bus technologies such as IDE, SCSI, PCI and InfiniB and. The interconnection element 514 enables communications, including instructions and data, to be exchanged between system components of the computer system 502.

The computer system 502 also includes one or more interface devices 516 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 502 to exchange information and to communicate with external entities, such as users and other systems.

The data storage element 518 includes a computer readable and writeable nonvolatile, or non-transitory, data storage medium in which instructions are stored that define a program or other object that is executed by the processor 510. The data storage element 518 also may include information that is recorded, on or in, the medium, and that is processed by the processor 510 during execution of the program. More specifically, the information may be stored in one or more data structures specifically configured to conserve storage space or increase data exchange performance.

The instructions may be persistently stored as encoded signals, and the instructions may cause the processor 510 to perform any of the functions described herein. The medium may, for example, be optical disk, magnetic disk or flash memory, among others. In operation, the processor 510 or some other controller causes data to be read from the nonvolatile recording medium into another memory, such as the memory 512, that allows for faster access to the information by the processor 510 than does the storage medium included in the data storage element 518. The memory may be located in the data storage element 518 or in the memory 512, however, the processor 510 manipulates the data within the memory, and then copies the data to the storage medium associated with the data storage element 518 after processing is completed. A variety of components may manage data movement between the storage medium and other memory elements and examples are not limited to particular data management components. Further, examples are not limited to a particular memory system or data storage system.

Although the computer system 502 is shown by way of example as one type of computer system upon which various aspects and functions may be practiced, aspects and functions are not limited to being implemented on the computer system 502 as shown in FIG. 5. Various aspects and functions may be practiced on one or more computers having a different architectures or components than that shown in FIG. 5. For instance, the computer system 502 may include specially programmed, special-purpose hardware, such as an application-specific integrated circuit (“ASIC”) tailored to perform a particular operation disclosed herein. In another specially-designed system, both hardware and software may be used to provide a new tool that performs one or more aspects of the present invention. Another example may perform the same operation using a grid of several general-purpose computing devices running MAC OS System X with Intel processors and several specialized computing devices running proprietary hardware and operating systems.

The computer system 502 may be a computer system including an operating system that manages at least a portion of the hardware elements included in the computer system 502. In some examples, a processor or controller, such as the processor 510, executes an operating system. Examples of a particular operating system that may be executed include a Windows-based operating system, such as, Windows Phone, Windows 7, or Windows 8 operating systems, available from the Microsoft Corporation, Android operating system available from Google, Blackberry operating system available from Blackberry Limited, a MAC OS System X operating system or an iOS operating system available from Apple, one of many Linux-based operating system distributions, for example, the Enterprise Linux operating system available from Red Hat Inc., or UNIX operating systems available from various sources. Many other operating systems may be used, and examples are not limited to any particular operating system.

The processor 510 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, Ruby, Objective-C, Java, C++, C# (C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### Example Interfaces

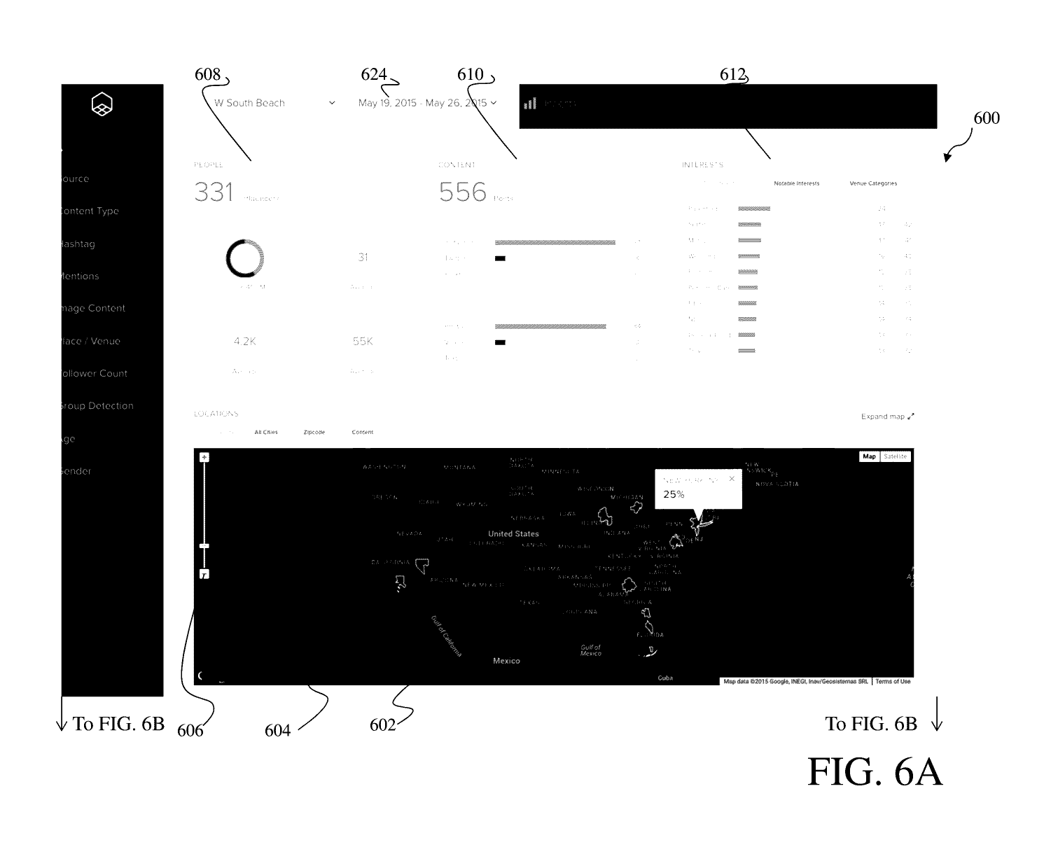

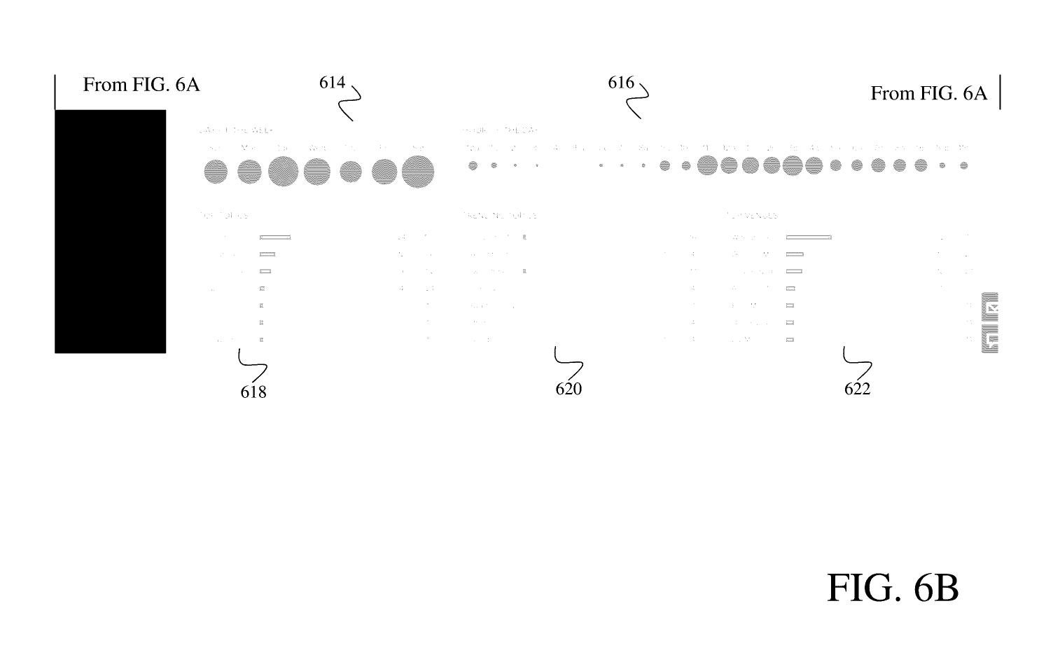

FIGS. 6A-B show an example interface (e.g., interface 600) for displaying and permitting a user to interact with a visualization, according to various examples. In particular, the interface 600 includes a visualization including an image 602 of a plurality of standardized geographic boundaries 604. FIGS. 6A-B show standardized geographic boundaries 604 in the states of California, Nevada, Florida, Georgia, Illinois, Michigan, Maryland, and New York. The interface 600 additionally includes a view indicator 606 permitting a user, or client, to zoom-in or zoom-out on the image.

In one embodiment, the interface 600 permits the user, or client, to interact with the geographically delineated content or author information associated with the standardized geographic boundaries 604 within the image 602. For example, this may include displaying associated geographically delineated content or author information. As shown in FIGS. 6A-B, the interface 600 additionally provides the user or client with one or more metrics, enrichments, statistics, or trends regarding the geographically delineated content or author information within the standardized geographic boundaries 604. For example, interface 600 may provide influencer data 608, content data 610, interests data 612, post volume data based on a day of the week 614 or an hour of the day 616, top topics 618, trending topics 620, and top venues 622. As described herein, the interface 600 may additionally provide a timeline indicator 624 permitting the user, or client, to define a time period from which the interface 600 will display geographically delineated content and author information.

As shown in FIG. 6A, displayed influencer data 608 may include the gender of influencers (shown as a percentage between male and female), the average age of the influencer, the average number of followers of the influencer, and the average income of the influencer. FIG. 6A, as shows the content data 610 including the number of total media posts, the volume of media posts from particular sources (e.g., Instagram, Twitter, and Flickr), and the type of content (e.g., Photo, Video, Text). Furthermore, FIG. 6A shows interests data 612 as including categories of top interests, notable interests, and venue. For example, each category may include a listing of interests of authors within the standardized geographic boundary, based on volume. FIG. 6A shows a list of top interests including, among others, “Parenting”, “Surfing”, “Music”, “Wedding”, and “Fashion”. Individual interests within the list may be ranked based on percentage of the total volume of media posts. Interest data may be based on influencers within a selected standardized geographic boundary, or all authors within a selected standardized geographic boundary.

As shown in FIG. 6B, day of the week post volume data 614 may be displayed by the interface 600 in a series of indicators, one indicator representing the post volume for each day of the week. For example, FIG. 6B shows a series of circles, each circle representing a post volume for a given day. Circles having a larger circumference are indicative of a larger post volume relative to other circles. Similarly, hourly post volume data 616 may be displayed by the interface 600 in a series of indicators, one indicator representing the post volume for each hour of the day. For example, FIG. 6B shows a series of circles, each circle representing a post volume for a given hour. FIG. 6B shows the largest post volumes within the span of 5 hours from 11 a-4 p.

As also shown in FIG. 6B, top topics 618, trending topics 620, and top venues 622 may be displayed as a list. Similar to displayed interest data 612, media post topics and venues may be ranked by volume and displayed to the user or client. Furthermore, increases or decreases in the volume of media posts may be ranked as trending topics. FIG. 6B shows the top topics including a ranked list of hashtags including, among others, “#miami”, “#southbeach”, “#miamibeach”, and “whotel”. The interface 600 may additionally display a percentage and/or a total volume associated with each topic within the ranked list. For example, “#miami” is shown at 24%, with a volume of 136. Trending topics 620 and top venues 622 may similarly include a ranked list as is shown in FIG. 6B. While not shown in FIGS. 6A-6B, in further embodiments the interface may provide the user or client with one or more detected incongruities, such as an identification of singular or groups of content or author information that is out of the ordinary for a particular place and/or time.

Accordingly, embodiments disclosed herein include services, application systems, applications, and methods for geographically delineated content provision. Geographically delineated content can include social media content that is relevant to one or more geographic locations, and information associated with the author whom generated the content. For example content can include text, photographs, videos, and/or audio files. Although social media content providers as described herein include social media platforms such as Twitter, Facebook, MySpace, Linkedln, Pinterest and Tumblr, in further embodiments, providers can include any social media content provider as is understood in the art.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only.

What is claimed is:

1. A computer system comprising:
an interface configured to receive an input defining a first standardized geographic boundary;
a location-based service including a distributed computer system having at least one processor in data communication with the interface;
a delineation component executable by the at least one processor and configured to aggregate geographically delineated content including a plurality of social media posts generated by an author and having an associated geographic location within the standardized geographic boundary; and
a communication component executable by the at least one processor and configured to provide the geographically delineated content.

2. The system according to claim 1, wherein the standardized boundary includes one of a predetermined state boundary, town boundary, neighborhood boundary, residential boundary, school boundary, hospital boundary, parcel boundary, zip code boundary, area code boundary, carrier route boundary, census boundary, shopping boundary, and subdivision boundary.

3. The system according to claim 1, wherein the input further defines at least one query parameter.

4. The system according to claim 3, wherein the query parameter defines author characteristics and the communication component is further configured to provide author information based on the author characteristics.

5. The system according to claim 4, further comprising a relation component configured to generate an advertisement based on the author information.

6. The system according to claim 3, wherein the query parameter defines content characteristics and the communication component is further configured to provide the geographically delineated content based on the content characteristics.

7. The system according to claim 1, further comprising a relation component configured to generate a visualization of the geographically delineated content including an image of the first standardized geographic boundary.

8. The system according to claim 7, wherein the relation component is further configured to filter the geographically delineated content.

9. The system according to claim 8, wherein filtering the geographically delineated content includes altering a resolution of the visualization to increase or decrease the first standardized geographic boundary to a second standardized geographic boundary.

10. The system according to claim 8, wherein each post of the plurality of social media posts includes a timestamp, and filtering the geographically delineated content includes filtering the geographically delineated content based on the timestamp.

11. The system according to claim 8, wherein each post of the plurality of social media posts includes author information, and filtering the geographically delineated content includes filtering the geographically delineated content based on author information.

12. The system according to claim 1, further comprising an enrichment component executable by the at least one processor and configured to aggregate enrichment data and enhance the geographically delineated content.

13. The system according to claim 1, wherein the system is configured to receive and store the geographically delineated content at a database, the database indexed based on a plurality of standardized geographic boundaries including the first standardized geographic boundary.

14. A computer system comprising:
an interface configured to receive an input defining at least one query parameter;
a location-based service including a distributed computer system having at least one processor in data communication with the interface;
a delineation component executable by the at least one processor and configured to aggregate geographically delineated content including a plurality of social media posts having an associated geographic location and generated by an author, based on the at least one search parameter;
a relation configured to identify a standardized geographic boundary for the geographically delineated content; and
a communication component executable by the at least one processor and configured to provide the standardized geographic boundary.

15. A computer system comprising:
an interface configured to receive an input defining at least one search parameter or standardized geographic boundary;
a location-based service including a distributed computer system having at least one processor in data communication with the interface;
a delineation component executable by the at least one processor and configured to aggregate geographically delineated content including a plurality of social media posts each generated by an author, based on the at least the one search parameter or standardized geographic boundary; and
a relation component executable by the at least one processor and configured to generate an advertisement targeted to one of an author of a social media post within the plurality located within the standardized geographic boundary or an author of a social media post within the plurality related to the query parameter.

16. A method comprising:
receiving an input defining a standardized geographic boundary;
aggregating geographically delineated content generated by one or more author for the standardized geographic boundary; and
providing the geographically delineated content.

17. A method comprising:
receiving an input defining at least one search parameter;
aggregating geographically delineated content generated by one or more author based on the at least one search parameter for a standardized geographic boundary; and
providing the geographically delineated content.

18. A method comprising:
receiving an input defining at least one search parameter or standardized geographic boundary;
aggregating geographically delineated content generated by one or more author based on the at least one search parameter or standardized geographic boundary; and
generating an advertisement targeted to one of an author located within the standardized geographic boundary or an author of a social media post related to the search parameter based on the geographically delineated content.
